(19) United States
(12) Patent Application Publication
(10) Pub. No.: US 2014/0156455 A1
(43) Pub. Date: Jun. 5, 2014

(54) Refrigerant Exchange, Recycling and Banking System and Computer Program Product

(71) Applicant: Polar Technology, LLC, Nashville, TN (US)

(72) Inventors: Ralph Ted Atwood, Franklin, TN (US); Chase Daniel Sanders, Dallas, TX (US); William Samuel Sanders, Greenville, SC (US)

(73) Assignee: Polar Technology, LLC, Nashville, TN (US)

(21) Appl. No.: 14/092,247

(22) Filed: Nov. 27, 2013

Related U.S. Application Data
(60) Provisional application No. 61/797,158, filed on Nov. 30, 2012.

(51) Int. Cl. G06Q 30/06; G06Q 10/08

(52) U.S. Cl. CPC G06Q 30/0607; G06Q 10/0875
USPC 705/26.25

(57) ABSTRACT

A refrigerant life cycle management and compliance tracking and monitoring system and method for maintaining large quantities of refrigerant stored and transported in bulk tanks and containers. The system is customizable and can be used to store, track and compile regulatory and status information about a refrigerant being transported in tanks and any other data relevant to the quality, status or custody of a tank and its contents. The system and method allow access to database information by compliance officers and inspectors for required regulatory reporting. The system and method are accessible through a web browser or mobile application.

### CROSS-REFERENCE TO RELATED APPLICATIONS

This application claims priority to U.S. Provisional Application No. 61/797,158, filed Nov. 30, 2012, the contents of which are incorporated herein by reference in their entirety.

### TECHNICAL FIELD

The disclosure relates generally to computer-based systems and methods for tracking, validating and monitoring the handling of regulated substances to ensure compliance with applicable industry standards and legal regulations.

### BACKGROUND

Refrigerants and other regulated gases are highly hazardous substances capable of causing significant environmental harm. Many refrigerants, particularly synthetic refrigerants, are important greenhouse gases and major contributors to ozone depletion and global warming. Accordingly, refrigerants are highly regulated substances that are the focus of worldwide regulatory scrutiny.

It is to be understood that various regulatory regimes, such as U.S. federal and state law and U.N. protocols, require tracking of refrigerants and refrigerant emissions during transport and verification of various steps of refrigerant disposal, recycling and reclamation, including verification of the disposal, recycling or reclamation of the substance and verification of the chain of custody during transportation of the substance to the disposal site, both as a function of their value and of the liability they pose if mishandled. For example, the U.S. Environmental Protection Agency (“EPA”) regulates refrigerant emissions, recycling and reclamation under Section 608 of the Clean Air Act and is presently considering additional measures to further regulate refrigerant and regulated gas leaks, production and use. California similarly regulates the sale, emissions and use of refrigerants in that state under Assembly Bill 32. Generally all of the various state, federal and international regulatory regimes mandate that detailed records regarding refrigerant and regulated gas storage, use and transfer be maintained and made accessible to the appropriate refrigerant regulatory entities (“regulators”).

Compliance with the various state, federal and international regulations is both costly and difficult. Companies that require refrigerants in the operation of their buildings or businesses (“regulated companies”) face significant and expensive challenges associated with monitoring emissions during storage, disposal and reclamation of exhausted refrigerants and regulated gases. These challenges have been amplified with the advent of processes for recycling exhausted refrigerants and gases due to the inherent difficulties of measuring and tracking gaseous substances, which are commonly stored in metal tanks and measured in pounds/pounds per square inch.

Current methods and systems for tracking refrigerants and regulated gases and building a maintenance history for a piece of equipment require significant human interaction and are time consuming, cumbersome, prone to error and subject to tampering and misreporting as they are completely manual. For example, methods and systems involving the use of handwritten or printed identification tags attached to tanks require a person processing the tanks to manually record the tag identification number and create a report regarding the transaction performed (e.g., transferred to, received by, volume measured, gas added or subtracted, etc.). These methods and systems generally do not provide for permanent identification of tanks or equipment because such tags can become separated from the associated tank or equipment. This deficiency also inherently limits the accuracy and reliability of the associated records by making such records susceptible to alteration by unauthorized personnel and do not allow multiple parties to validate the records.

Traditional refrigerant tracking and management systems are also often rudimentary in that they involve one or more of the following: (1) paper files containing reports of refrigerant purchases and returns; (2) collecting reports of an aggregate bulk measurement (pounds) returned by the regulated company at the end of every quarter; (3) Microsoft Excel format spreadsheets listing refrigerant transactions; or (4) the regulated company managing its own internal records/system based on information related to refrigerant transactions. Such approaches are inconsistent, slow, unreliable, difficult to perform and do not provide a high degree of confidence that the refrigerant or other regulated gas in the tanks was measured and handled in accordance with applicable regulatory requirements or that a regulated company's records were accurately updated after transfer because they are not coordinated or automated. These systems also fail to provide an automated way to quickly and easily determine the location or disposition of one or more specific tanks of refrigerant.

Available systems also do not provide for the tracking of refrigerant and other regulated gases as they are transferred from the original seller to the regulated company and later to a third party for recycling or disposal because they lack a way to track consumption, conversion, leakage or loss of refrigerant after the initial sale to the regulated company. For example, current systems do not track the disposition of refrigerant after it has been reclaimed and removed from a regulated company's facility, nor do they account for gas loss (e.g., due to chemical conversion or leaks) over time. These deficiencies present serious risk to regulated companies who remain legally responsible for the refrigerant even after it has been transferred to a third party for disposal or recycling.

Moreover, even systems that do track refrigerant after it leaves a regulated company do so with general asset management software designed merely to track equipment and which ignores the regulations governing the handling of hazardous refrigerants. Other systems are narrow in their usefulness. For example, the system described in U.S. Pat. No. 8,000,938 provides an asset management system that calculates the carbon credit offset during the refrigerant destruction process. That system does not provide for refrigerant banking or account for gas through its entire life cycle as it is transferred into and out of equipment.

### SUMMARY

Accordingly, there is a need for a computer-based refrigerant banking or exchange system that can reliably and accurately track the amount of refrigerant exchanged through multiple recycling, reclamation and disposal transactions. There is also a need for a computer-based system and method that can reliably track the life cycle of regulated gases as they are transferred into and out of equipment to ensure compliance with handling, disposal and emissions regulations. There is also a need for such a system that will maintain accounts of all refrigerant returned by a system user or servicer to a wholesaler or reclamation facility to allow credit toward future purchases of pure (virgin) or recycled refrigerant or other regulated gases.

More specifically, what is needed is a cloud-based computer system and method that can: (1) track purchases of multiple types of refrigerants; (2) easily distinguish between, identify and manage multiple tanks of refrigerant and equipment (each item of refrigeration equipment); (3) assign a unique and permanent identification tag or number to each tank and each piece of equipment; (4) store and manage data regarding the properties of the refrigerant in each tank and piece of equipment; (5) determine and track gas properties for one or more tanks and equipment; (6) interface and exchange data with existing systems used by refrigerant distributor networks; (7) interface and exchange data with the various existing inventory systems used by regulated companies; (8) maintain and manage a history of the contents for each tank of refrigerant and each piece of equipment; (9) maintain and manage a history of the location and movements of each tank of refrigerant; (10) automatically update the properties of the refrigerant in a tank as it is used, transported, recycled, stored, etc.; (11) track and verify the chain of custody of each tank of refrigerant; (12) account for and distinguish between refrigerant obtained from multiple sources; (13) track the volume of refrigerant inventory removed or reclaimed after it is expended, exhausted and/or has lost effectiveness; (14) track the changes in the amount of refrigerant in tanks and equipment to detect leaks in equipment; (15) track the re-disposition and/or disposal of refrigerant after it has been transferred to a third party recycling or disposal company; (16) track the return of the tanks of recycled or reclaimed refrigerant, if the refrigerant is recycled or reclaimed; (17) track the refrigerant during transportation between facilities and equipment; (18) provide and obtain information about the refrigerant and equipment to different industry sectors controlling the life cycle of the refrigerant (i.e., owners, distributors, wholesalers, regulators, recyclers, etc.); (19) communicate gas properties to remote and local system users; (20) provide interactive tools geared to each of the particular sectors controlling the life cycle of the refrigerant; (21) operate independent of any specific reader, tablet or computer system; (22) provide a coordinated platform for recycling, reclamation and repurchase (or return) of refrigerants; (23) instantly generate customized reports on demand to show a regulator the pedigree and gas properties of each tank of refrigerant in the system; and (24) manage and fulfill regulatory requirements.

The present system is designed to meet the existing need in the art for a refrigerant banking or exchange system by providing computer systems and computer implemented methods that allow for tracking, organizing, monitoring and maintaining large quantities of refrigerant stored in tanks, cylinders, or other containers (“tanks”) or used by a piece of refrigeration equipment that uses refrigerant or other regulated gases, such as refrigerators, coolers, air conditioners and other machines. In particular, the system provides a tank, equipment and refrigerant life cycle management system for managing compliance with applicable regulatory requirements and industry standards governing refrigerant emissions and disposal by monitoring, tracking and verifying the handling, transfer and chain of custody of refrigerants and refrigerant tanks during storage, operation and transportation for disposal, recycling and reclamation and equipment during operation. In some embodiments disclosed herein, the refrigerant management system for managing the destruction, recycling or reclamation of one or more refrigerants is a network- or cloud-based system.

The system and method is not simply for determining the location of tanks, but was designed to track and manage information about the entire life cycle of equipment and refrigerant tanks (and the gas properties of their contents), increase efficiency of transfer and tracking of refrigerant tanks, decrease human error during the tracking and management process and monitor service events and maintenance on equipment.

The system decreases costs and increases efficiency over existing systems by providing an easy to use, inexpensive refrigerant management system that electronically stores, tracks, validates and compiles and directs users according to regulatory requirements and status information about the refrigerant in a tank or in a piece of equipment maintained in a database, including but not limited to the type of refrigerant, the date of purchase of the refrigerant, purchase order number, receiving department, the volume of refrigerant, the purity of the refrigerant, return authorization information, transfer date, tank identification number, testing date, location identification, asset identification number, tank size and capacity, tank pressure, amount of refrigerant credited to the customer's account and any other data relevant to the quality, status or custody of the tank, a piece of equipment and their contents (with respect to refrigerants, “refrigerant properties” or with respect to gases generally, “gas properties”). The system also has the capability to provide an alert if the system determines that a given piece of equipment has a leak. Because the refrigerant management system is highly automated and tracks standardized information, it eliminates the slowdown in workflow commonly associated with manually recording identification information and calculating and determining properties for a piece of equipment (such as leak rate). It also provides the ability to limit access to different features of the system to authorized personnel.

Additionally, the refrigerant management system allows users to manage refrigerant reclamation across many facilities and allows regulated companies to assess the availability of refrigerant so that it can be reallocated to facilities in need of additional refrigerant. The system can also be configured to monitor the timing and completion of refrigeration equipment maintenance, refrigeration equipment replacement, tank replacement, refrigerant recycling, reclamation, depreciation calculations, cost savings and return on investment.

Embodiments also assist in the monitoring of gas liabilities. In some jurisdictions, an amount of a particular gas is associated with a particular financial liability, e.g., to cover environmental damage in the case of a leak. By monitoring the amounts and types of gases possessed by a company, embodiments assist in the management of liabilities of such a company.

In one implementation, a provided method includes monitoring refrigerant recycling, and allowing a company to repurchase reclaimed refrigerant.

In one example, a method is provided. The method includes attaching a radio frequency identification (RFID) tag to a tank, assigning the RFID tag to an identification number corresponding to the tank's record in a database, and maintaining a history of a tank, including refrigerant properties. In a further example, the refrigerant properties include a purity of the refrigerant and a gas type.

In one embodiment, a method of managing a refrigerant is provided. The method includes receiving a customer ID, receiving a first amount of the refrigerant in a tank, crediting the first amount of the refrigerant to an account based on the customer ID, determining a difference between the first amount of the refrigerant and a second amount of the refrigerant, and removing the second amount of the refrigerant from the account.

The method can include receiving a purity of the refrigerant in the tank. The method can also include receiving a gas type of the refrigerant in the tank. The method can additionally include paying account for the second amount of the refrigerant.

Another embodiment provides a method including identifying a plurality of tanks containing a refrigerant using assigned tags; associating each tank with an electronic record for that tank; and retrieving a gas type, weight and purity of the refrigerant based on the assigned tag.

### BRIEF DESCRIPTION OF DRAWINGS

The features and advantages of various embodiments of the refrigerant management system disclosed herein may be better understood by reference to the accompanying drawings, briefly described below, in conjunction with the following detailed description.

FIG. 1 is a block diagram showing the components of one embodiment of a refrigerant management system, for a tank and a regulated company.

FIG. 2 is a flow chart illustrating one embodiment of an algorithm for refrigerant banking using a refrigerant management system.

FIG. 3 is a flow chart illustrating another embodiment of an algorithm for refrigerant banking using a refrigerant management system when returning gas to a wholesaler, reclaimer or distributor.

FIG. 4 is a flow chart illustrating an algorithm for detecting leaks in a piece of equipment using a refrigerant management system.

FIG. 5 is a flow chart illustrating an algorithm for monitoring the periodic leak rate of a piece of equipment using a refrigerant management system.

FIG. 6 is a flow chart illustrating an algorithm for tracking maintenance of a piece of equipment using a refrigerant management system.

FIG. 7 is a flow chart illustrating an algorithm for coordinating logistics for a technician based on refrigerant required to service a piece of equipment using a refrigerant management system.

FIG. 8 is a flow chart illustrating an algorithm for detecting technician fraud or error in filling refrigeration equipment with refrigerant using a refrigerant management system.

FIG. 9 is a block diagram showing the components of one embodiment of a computer system for implementing a refrigerant management system.

### DETAILED DESCRIPTION

It is to be understood that the specific devices and processes illustrated in the attached drawings and described in the following specification are exemplary embodiments of the inventive concepts defined in the claims below. Hence, specific dimensions and other physical characteristics relating to the embodiments disclosed herein are not to be considered as limiting, unless the claims expressly state otherwise.

System Components

In one embodiment, the refrigerant management system comprises at least one of each of the following: a central processor or server 120 in communication with a database 100 over a network 115; a first user interface 110 (such as a local device, a mobile device or other processor) in communication with the central processor or server 120; a second user interface 125 in communication with the central processor or server 120; refrigerant management system software 105 on the central processor or server 120; a local device 130 (such as a mobile device) in communication with the central processor or server 120 over a network 115; refrigerant tanks 150; and tracking tags 145 labeled, bearing or encoded with unique identification information, wherein each unique tracking tag 145 is attached or coupled to a different tank 150 or piece of equipment 155 to distinguish and identify each tank 150 and piece of equipment 155. The system uses tags 145 (or other suitable identification devices) to identify and track tank 150 and equipment 155 location, transfer, ownership and maintenance, as well as other relevant information about each tank 150 or piece of equipment 155 and their contents.

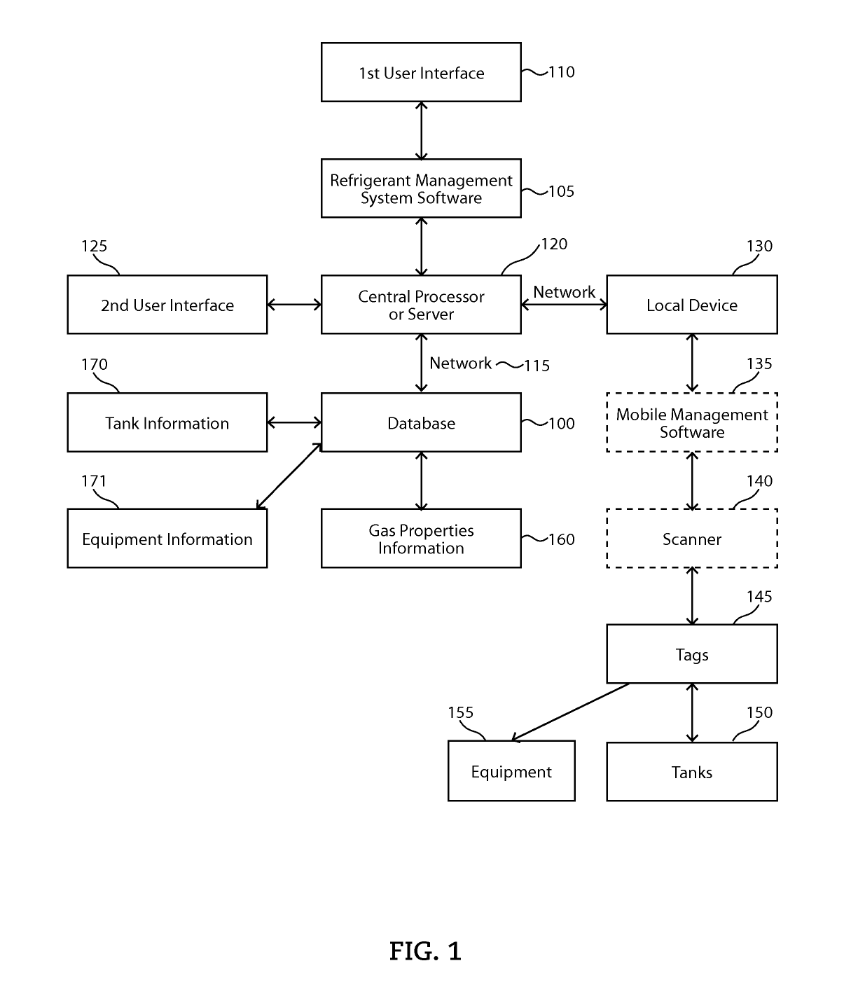

In one embodiment depicted FIG. 1, the system further comprises a mobile version of the refrigerant management software 135 (shown in broken lines) on the local device 130 and a tag scanner 140 (shown in broken lines) in communication with the local device 130. The local device 130 can be located at one or more of the site locations of a regulated company and/or at other locations, such as third party sites. The local device 130 is in communication with tanks 150 through the tag scanner 140, and the tag scanner 140 scans tags 145 that are attached to the tanks 150. In some embodiments, the scanner 140 and the local device 130 are included in the same device, such as an iPad or other tablet computer.

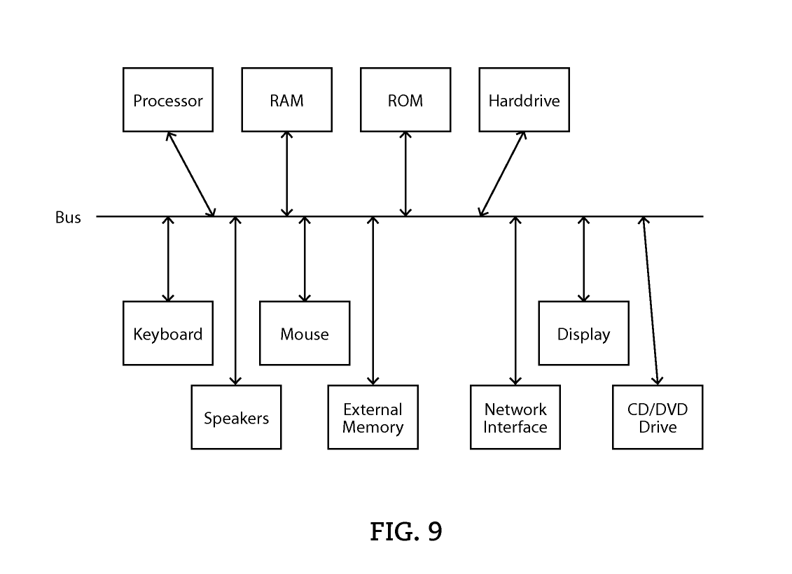

The central processor or server 120 can comprise a central processor and main memory, an input/output interface for communicating with various databases, files, programs, and networks (such as the Internet), and one or more storage devices. The server can also have a monitor or other screen and an input device, such as a keyboard, a mouse, or a touch sensitive screen. The network 115 can be a local area wired or wireless network. In one embodiment, the central processor 120 communicates with the database 100 through a different network than the local device 130 and/or scanner 140. It is to be understood that the central processor or server 120 can be any computer known to those skilled in the art, including, for example, a computer comprising the components illustrated in FIG. 9.

The server 120 includes a refrigerant management system software program 105 that processes requests and responses from a local device 130 or user interface 110, 125. The software program 105 on the server 120 sends information to a local device 130, performs calculation, compilation, and storage functions, transmits instructions to the local device 130, and generates reports. The server 120 allows the local device 130 to access various network resources. The local device 130 and server 120 can each have separate software applications installed on them that exchange data with the refrigerant management system software 105 or the local device 130 can access the refrigerant management system software 105 directly without a locally installed mobile management system. Any number of local devices 130 can be connected to the server 120 and utilize the system remotely at any given time.

It is to be understood that any embodiment of the system disclosed herein that provides for data collection, storage, tracking, and managing can be controlled using software associated with the system. It is to be further understood that the software utilized in the various embodiments described herein can be a modified version of a software application or applications that are commercially sold and normally used by those skilled in the art or it can be a custom application or applications.

The database 100 can be integral to the server 120 or it can be accessible to the server 120 through a computer network 115 or other suitable communication link. The database 100 and database management system are capable of storing information about tanks 150 (and the gas properties of tank contents) and the equipment 155, but the particular type of database or database management system can be any type generally known in the art, such as a SQL server database. The database 100 for the refrigerant management system can be located on a network 115 or in a cloud environment so that its records can be accessed from any location through a web-based user interface, mobile device or other remote user interface.

A user interface 110, 125 may be any computer known to those skilled in the art. In some embodiments, a user interface 110, 125 is a computer comprising various hardware and peripheral components that communicate with each other via a system bus. In one embodiment, a user interface 110, 125 is a computer comprising the hardware and peripheral components illustrated in FIG. 9.

The database 100 contains records for storing information about tanks 170 equipment 155 and their contents, including but not limited to, equipment location, tank location, actions taken on a tank or piece of equipment, and the properties of the refrigerant in a tank 160 or piece of equipment 155; user identification, permissions and restrictions; and information about any tanks, refrigerant, and refrigerant equipment associated with or owned by a refrigerant producer, distributor, wholesaler, disposal company, recycler, reclamation company, regulated company and any of their personnel (individually, a “customer;” collectively, “customers”), such as the location and number of tanks and equipment and the aggregate amount of refrigerant or regulated gas associated with or owned by the customer in each tank or piece of equipment. The database 100 also includes data fields for storing the source and location of the pounds of refrigerant associated with a customer's system account (“customer account”).

Each customer account is assigned a customer identification number (“Customer ID”), which is specific to and identifies each customer. All records for a given customer account are linked to or associated with the Customer ID. Once a new customer account is opened and a Customer ID assigned thereto, a record containing the various data fields described herein is created and linked to or associated with the Customer ID in the database 100 for each tank or piece of equipment to be tracked. Each tank 150 is affixed with a unique identification tag 145 having an identification number or other identifying information encoded, embedded or printed thereon (“Tank ID” or “Tag ID,” interchangeably) which is used to link or associate a given tank with its corresponding record in the database 100. Each item of refrigeration equipment or piece of equipment 155 is similarly affixed with an identification tag or assigned an asset identification number (or its manufacturer serial number can be used) (“Asset ID”), which is used to link or associate a given piece of equipment with its corresponding record in the database.

At this point, information relating to each tank 170 or piece of equipment 171 can be collected. That is, certain characteristics or information about each tank or piece of equipment and their contents can be entered into the applicable database record. Basic tank and equipment data such as the tank or equipment serial number (assigned to each tank or piece of equipment by the original manufacturer) and Tank ID or Asset ID is uploaded into the database 100 by the refrigerant management system and associated with the corresponding database record, enabling the system to locate and retrieve the record for any given tank or piece of equipment by Tank ID or Asset ID, respectively. In one embodiment, tank and gas properties and related information are entered into the system via a local device 130, transmitted over the network 115 to the central processor or server 120 and stored in the database 100. Additional relevant information relating to the refrigerant, including the transportation, and/or the destruction thereof, can be entered into the system by any of the methods or devices described above. That is, the information can be manually entered by a user or automatically entered by the system. Records are built in the database 100 through updates over time.

To protect the integrity of the records, the database 100 can also be restricted by the system (including by use of a passcode or “User ID”) so that only authorized users can access or modify information contained in one or more records. The term “user” as employed herein refers to users of the refrigerant life cycle management system, which include but are not limited to owners of refrigerant, tanks and equipment, refrigerant producers, distributors, wholesalers, disposal companies, recyclers, reclamation companies, regulated companies, regulated servicing companies, regulators and any of their personnel (each a “user” of the system or “system user”).

In one embodiment, a system user can enter the following information into the system database 100: (1) Location ID (e.g., an alphanumeric code used by the recycling/disposal company assigned to identify the geographic location of the facility where the tank is received or the equipment is located); (2) return authorization information (e.g., a return authorization number created to identify and track a particular tank or collection of tanks of refrigerant); (3) purchase or transfer date (the date the refrigerant tank was transferred to the recycling/disposal company); (4) tank or equipment serial number (e.g., the identifying serial number assigned to each tank or equipment by its manufacturer); (5) Tag ID (e.g., an identifying number of an identifying tag that correlates a user to an assigned tank or piece of equipment); (6) refrigerant type (an identification of a predominant refrigerant type contained in the tank or piece of equipment); (7) purity (a relative purity of refrigerant measured on receipt of the tank by the recycling or disposal company); (8) testing date (the date the purity of the refrigerant is tested); (9) tank or equipment capacity (the volume of the tank or equipment); (10) volume of refrigerant (the volume of refrigerant in the tank or equipment); (11) tank pressure (the pressure of the tank or equipment in PSI); (12) receiving department (the department receiving a given tank of refrigerant); (13) purchase order number (e.g., the purchase order number for a purchase order requesting a given tank); and (14) actions taken (the actions taken on a given tank, for example, during a service event.

The refrigerant management system can use various software interfaces to establish an electronic data exchange with the inventory management system used by a regulated company or other customer and with management systems used by other third parties involved in the life cycle of the customer's refrigerant. The refrigerant management system can be designed to communicate and maintain information about tanks, equipment and the gas properties of their contents as the tanks move between each of these different parties. It may also further comprise the ability to allow a person handling refrigerant to manually enter the physical location of the tank within a facility, or can accept GPS or other location information from a local or mobile device to record the exact location of the tank during testing, refilling, recycling or transport (whether by Location ID, facility name, or by physical location within a facility).

Tags and RFID

The system employs pre-assigned identification tags attached to each tank or piece of equipment being tracked by the refrigerant management system to facilitate the storage, maintenance and retrieval of information about each tank or piece of equipment and its refrigerant contents. Tags can be bar coded, serial numbered, digitally encoded or physically marked with any type of suitable identification information. Tags can be attached to tanks or equipment by any suitable means, including but not limited to adhesive, snaps and/or clips. Tags can also be attached to the tanks or equipment at the time of initial sale to a regulated company. The information carried on the tag can be as basic as a Tank ID or Asset ID, or can also carry additional identification information about the tank and the gas properties of its contents.

The refrigerant management system uses the Tank ID or Asset ID to identify and track the tank or piece of equipment to which it is attached and their refrigerant contents. The system associates the Tank ID or Asset ID with a corresponding electronic record for that tank or piece of equipment maintained in the database by the refrigerant management system. Upon receiving the Tank ID or Asset ID for a given tank or piece of equipment, the system may retrieve the corresponding electronic record from the database for display to a user (for example, via a user interface) or determine the Customer ID or Location ID associated with the Tank or Asset ID received. In this way, the record for each tank and piece of equipment and the gas properties of their contents is not impacted if a tag is damaged because the record is stored in the database of the refrigerant management system. In preferred embodiments, the information stored on or in a tag cannot be easily altered or worn off by an unauthorized individual upon seeing the tank without replacing the tag.

One type of tag suitable for use with the system is the radio frequency identification (“RFID”) tag. RFID systems can be either active or passive. With active RFID, the RFID tag uses an internal power source to transmit a radio frequency to an RFID tag scanner (interchangeably referred to as a “reader”). Active RFID tags hold more information and transmit information across longer distances than passive RFID tags. However, active RFID tags are battery operated and require periodic power source maintenance. Passive RFID tags rely on a strong signal being sent from an RFID tag scanner to activate the tag to reflect a signal back to the scanner. Passive RFID tags have a longer lifetime since they are not dependent on a finite power source, but can only transmit a signal over a short distance and are capable of transmitting less information than active RFID tags. RFID tags have not previously been used in the refrigeration industry for tracking refrigerants, refrigerant tanks, or refrigerant equipment. Near Field Communications (NFC) technology is one example of a suitable RFID technology.

In one embodiment, RFID tags are used to identify each refrigerant tank and update a corresponding database record in conjunction with one or more RFID tag scanners. For example, when a tag is scanned or read with a scanner in communication with the refrigerant management system, the system receives the Tank ID from the scanner and retrieves the corresponding record for the associated tank from the database. The refrigerant management system then communicates the retrieved record to the user for review or modification through a local device, which can be a mobile device such as a phone or tablet computer. In another embodiment, the RFID tags can be programmed with additional information, including security and password protection. In some embodiments, the information stored on the RFID tags is formatted in accordance with the International Standards Organization (e.g., ISO 9001:2008) guidelines to allow for use of the tagged tanks with multiple existing asset management systems.

Although the present refrigerant management and tracking system can alternatively use a different tagging mechanism to track individual tanks, such as an automated or electronic tag sensing system, specific pass-codes/IDs, or any another suitable location identification system or method, radio frequency identification offers certain advantages over existing identification methods including, for example, that an RFID tag scanner need not be within line of sight of a target RFID tag, as is required with systems such as bar coding. This benefit of RFID reduces errors and facilitates identification and retrieval of the record for a tank without the need for manual entry of the Tank ID. This is especially important because many tanks are otherwise identical to each other and are often heavy and cumbersome to handle and scan. Reducing the physical labor required to scan RFID tags on tanks saves money.

The refrigerant management and tracking system can use either active (battery operated) or passive (no battery) RFID tags, according to customer preference. Some customers prefer active RFID tags even though they will require battery changes because they can be constantly monitored over greater distances. Other customers prefer passive RFID tags because they are less expensive and have greater longevity. Although an RFID tag scanner must generally be held closer to passive RFID tags to obtain a signal, range is not a critical factor for the present refrigerant management system because refrigerant tanks are subject to various regulations requiring physical transfer, inspection, and refilling and are typically stored in a designated location. For example, tanks (and their attached RFID tags) can easily be placed within range of an RFID tag scanner during transfer, inspection or refilling, or a mobile scanner could be used in the applicable tank storage areas as suits a customer's needs. The particular type or brand of scanner can vary so long as it is compatible with the particular RFID tags being used with the tanks and is in communication with the refrigerant management system (or with a customer's inventory management system, which itself is in communication with the refrigerant management system). In one embodiment of a method, the method comprises identifying a plurality of tanks using pre-assigned tags and communicating a gas type and purity of the refrigerant of the contents of the tanks.

Accordingly, in one embodiment, the refrigerant management and tracking system comprises the method of: attaching an RFID tag with an encoded identification number to a refrigerant tank; assigning the identification number of the RFID tag (and its corresponding tank) to a corresponding record in the database of the refrigerant management system; and building a record of the history of the tank and its contents in the refrigerant management system's database by periodically updating information about the tank and its gas properties.

Refrigerant Banking

In one implementation, the system tracks the aggregate amount of refrigerant associated with a particular customer account when tanks or refrigerant are returned to a wholesaler, reclaimer, or distributor. The system allows the refrigerant to remain stored in multiple tanks, be transferred from tank to tank, or be transferred from a tank to equipment while accounting for each such transaction. In one embodiment, a customer can return tanks containing a pure refrigerant for credit applied to the customer's “gas bank” for the returned gas. A customer “gas bank” is an account managed by the refrigerant management system that maintains a running total of the refrigerant owned by a given customer that has been returned for storage and later use or resale. The system maintains a running total in a gas bank by crediting a customer's gas bank account with the weight of each type of pure gas returned, and debiting the appropriate gas bank account with the weight of each type of pure gas (or reclaimed gas) withdrawn or repurchased. The system monitors refrigerant recycling and allows a customer to repurchase reclaimed or recycled refrigerant.

Industry standard refrigerants having a purity above 99.5% are considered “pure” gases of the given refrigerant type whether that industry standard refrigerant is comprised of a single gas or a blend of gases. The term “mixed” gas refers to a non-industry standard mixture of gases, often the result of accidental mixing of pure refrigerant gases into the same tank. The term “contaminant” refers to non-refrigerant substances that have been introduced to a tank, such as moisture, oil, dirt, rust, etc. All pure industry standard gases are banked separately. Mixed gases may be banked separately or together since they are already mixed. Contaminants found in tanks are accounted for and deducted from the weight of banked gases.

The system matches returned gas to the appropriate bank for that gas in a customer's account based on the tags associated with the tanks and their gas properties. Once a customer has a positive balance of a pure gas in the customer's gas bank the customer can receive gas back or transfer it to a third party. Upon receipt of a purchase order or transfer order from a customer by the system, gas is debited from the customer's bank and either shipped to the customer in tanks or credited into a third party's gas bank. In one embodiment, the method comprises monitoring refrigerant recycling as tanks are returned and testing the purity of gases being returned and allowing a customer to repurchase reclaimed refrigerant.

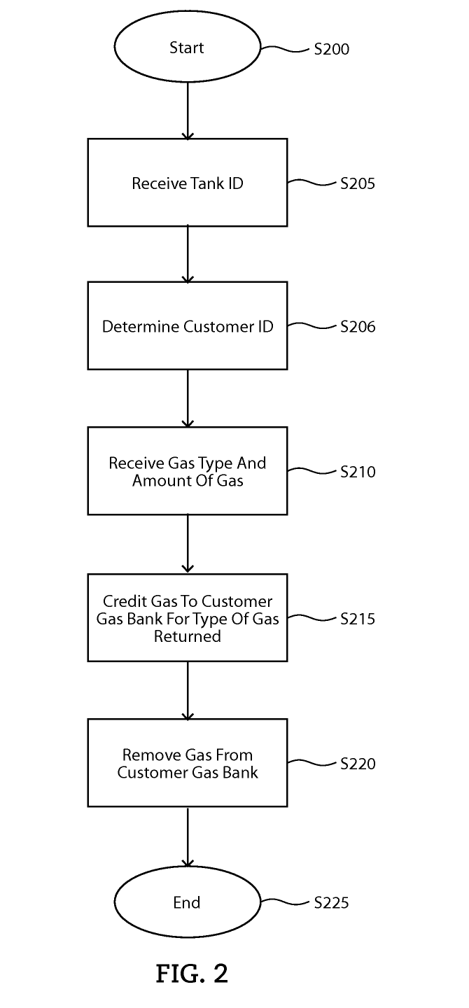

FIG. 2 illustrates one embodiment of a method of banking refrigerant gas. The method can be performed, for example, when a user returns a refrigerant tank containing pure gas. The method begins at S200 and proceeds to S205 when the system receives the Tank ID from the tag attached to the tank being returned such as upon return of a tank. The system then uses the records in the database to identify the Customer ID associated with the Tank ID of the tank being returned S206. A technician identifies the type and weight of the gas in the tank at the reclaimer or recycler via lab analysis. The system receives the type and amount of gas in the tank S210. The system then credits the customer gas bank for the particular gas received that corresponds to the Customer ID with the weight of gas received S215. Pure gas is credited to a pure gas bank of the type of the returned gas (e.g., R22). In one embodiment, mixed gas is credited to a mixed gas bank including all types of mixed gas. In an embodiment in which financial liabilities are tracked, the liabilities are decreased by the amount of gas returned. The system stores banked gas is stored in the customer's gas bank for the type of gas returned until such time as, e.g., a service request or maintenance event, or a customer orders virgin gas or otherwise transfers gas out of that bank. Upon receiving the order, the system determines the difference between the amount of gas in the customer's gas bank and the amount requested in the purchase order. Then the gas is removed from the customer's gas bank S220. At this time, the liabilities of the company withdrawing the gas can be increased. The method ends at S225. The customer's gas bank and customer account is maintained until another transaction is initiated S200. A customer can log into the system to view the real-time aggregate gas in their bank total for a particular type of gas at any time. In another embodiment, the system can be used to bank the quantity of mixed gas returned by a customer and further comprise determining a carbon offset credit for the customer once the mixed gas is destroyed or reclaimed based on the amount of mixed gas in the customer's account that is destroyed or reclaimed by the reclaimer.

Accordingly, in one embodiment of a method of banking refrigerant gas, the method comprises (1) receiving the Tank ID, (2) determining the Customer ID associated with the Tank ID received, (3) receiving the amount and type of gas in the tank, (4) posting pure gas to the customer's gas bank for the type of gas returned based on the Customer ID, (5) determining the difference between an amount of gas requested to be removed from customer's gas bank and the amount posted to the customer's account and (6) removing gas from the customer's gas bank.

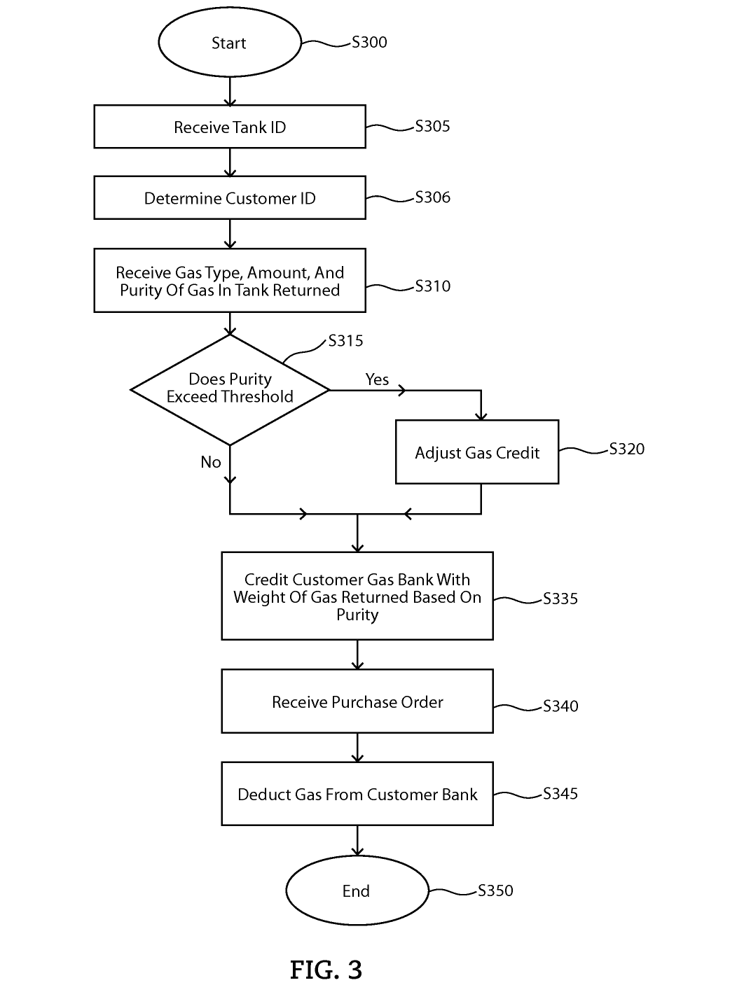

FIG. 3 illustrates another embodiment of a method of banking refrigerant gas. The method may be performed, for example, when a user returns a refrigerant tank containing pure, mixed, or contaminated gas. The method is initiated at S300 and proceeds to S305 when the system receives a Tank ID. The system then uses the Tank ID received in S305 to determine the corresponding Customer ID S306. A technician tests the gas in the tank to determine whether the gas is an industry standard, mixed or contaminated gas, and the purity of the gas. The system receives the type, amount, and purity of gas in the tank S310. If the tank contains an industry standard gas of over a certain purity threshold (e.g., 99.5%) S315, the system adjusts the weight of the gas credit downward by a certain percentage to account for contaminants and gas used up during analytical testing S320 and credits the customer's gas bank for the particular gas with the adjusted weight of gas received S335. In one embodiment, the system reduces the weight of pure gas received by 10% or an estimated average amount gas used during testing and contaminants. Alternatively, if the tank contains an industry standard gas of less than the purity threshold S315, the system credits the customer's mixed gas bank with the weight of gas received S335. Banked gas is stored in the customer's gas bank until such time as the customer submits a purchase order requesting withdrawal of gas from the gas bank credited. Upon receipt by the system of a purchase order S340, a corresponding amount of gas is debited or deducted from the specified gas bank S345 and the method ends 350. The debited gas may be sent to the customer in the original tank or transferred to a virgin tank for transport. In an embodiment in which the system tracks a financial liability of gas, the liability of the gas is increased to reflect the withdrawal of gas.

In one embodiment of a method of banking refrigerant gas, the method comprises (1) receiving the Tank ID, (2) determining the corresponding Customer ID based on the Tank ID, (3) receiving the amount, type and purity of gas in the tank, (4) determining whether the purity of the gas exceeds a predetermined threshold (e.g., 99.5%), and if so, adjusting the weight of the gas, (5) crediting the corresponding customer gas bank for the type of gas received with the (possibly adjusted) weight of gas received based on purity, (6) receiving a purchase order, and (6) deducting gas from the customer's gas bank based on the purchase order.

The system allows an authorized user to view the aggregate refrigerant owned or controlled by a given customer and withdraw refrigerant from a gas bank associated with that Customer ID. A customer having a positive balance in its bank for a particular refrigerant can withdraw some or all of the banked gas. For example, a customer who desires to withdraw 60 lbs of refrigerant at the clean and return price can: (1) log into the software program; (2) open a “Clean and Return Inventory” page; (3) click “Remove lbs” next to the Customer ID (e.g., “Company 1”); (4) enter the number of lbs desired and the date in a pop-up window by saying “Enter Reference sales number:110256”; and (5) once the authorized user clicks “enter,” the system automatically removes 60 lbs from the customer's gas bank. The clean and return inventory page will update to reflect the removed refrigerant. An authorized user can also select “see history” next to a Customer ID to view each refrigerant transaction made by the customer. The refrigerant management system provides chain of custody verification by updating the records automatically as tanks containing the requested gas are processed.

Regulatory Compliance Management

Many federal, state and local governmental agencies require monitoring and verification of various aspects of regulated substance use, storage, transfer, reclamation and destruction, including monitoring of refrigeration equipment for leaks over time and verification of the chain of custody of tanks during transportation from one site to another. Various embodiments of the methods and systems disclosed herein facilitate compliance with all such applicable regulations.

The refrigerant management system is an interactive tool providing for dynamic data personalization and the ability to create customizable reports to show and filter for certain characteristics about the tanks and their refrigerant contents. By contrast, other systems require the manual creation of separate reports depending on what data is needed (i.e., by gas type, tank or cylinder size, PSI, technician, etc.). In addition, the present refrigerant management system can instantly show a regulator the compliance history and gas properties of any number of tanks or equipment without physically locating them. The system can also retrieve and display the record of compliance history and gas properties of a particular tank or piece of equipment in response to an inquiry about that particular tank or piece of equipment, or in response to a user scanning a given tag.

For example, one embodiment of the refrigerant management system provides a convenient, easy to use solution for tracking tanks and equipment (and the gas properties of their contents) over the life of the tanks, equipment and/or refrigerants in them, which allows for automated data exchange between numerous parties, including owners of refrigerant, tanks and equipment, refrigerant producers, distributors, wholesalers, disposal companies, recyclers, reclamation companies, regulated companies, regulators and any of their personnel, so that the history of tanks and equipment can be reliably audited and reported without the need for a regulator or representative of the regulated company to physically retrieve a tank or visit a piece of equipment during an audit. By providing a platform for creating an auditable pedigree for refrigerants, the tanks that hold them and equipment that uses them, the system reduces a customer's regulatory risk and facilitates regulatory reclamation and disposal compliance.

Equipment Leak Identification, Management and Monitoring

In another implementation, the refrigerant management system provides a method for identifying and managing leaks in equipment and monitoring equipment for refrigerant leaks over time. Each piece of equipment tracked by the system is assigned an Asset ID based on the serial number assigned to the equipment by the original manufacturer or the identification number of an identification tag affixed to the equipment. Like with refrigerant tanks, the system creates a record in the database for each piece of equipment to be tracked. The Asset ID is used to link or associate a given piece of equipment with its corresponding record in the database. The applicability of various regulations is determined based on the zip code in which the equipment is located and the properties of the particular piece of equipment. The zip code of each piece of equipment is associated with the Asset ID, stored in the database record for the corresponding equipment and used as a geographical indicator by the system for identifying the applicable regulations. The zip code can be updated by, e.g., incorporating a GPS device into the scanner or can be updated manually.

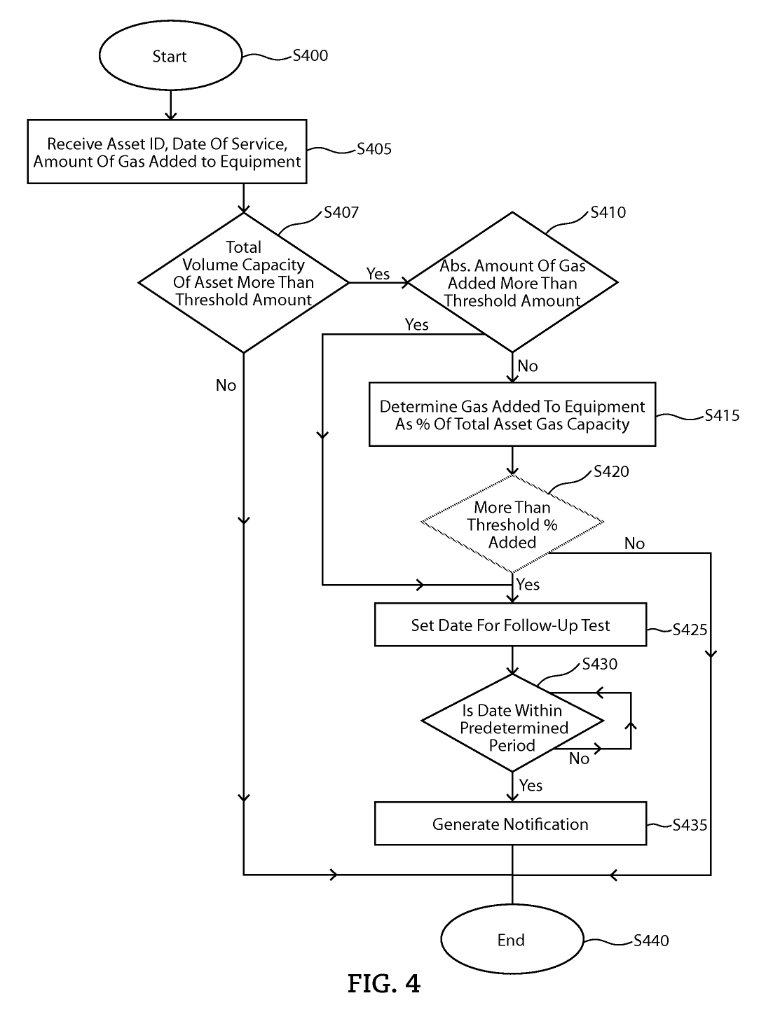

FIG. 4 illustrates one embodiment of a method for identifying and managing leaks in equipment. The method may be initiated, for example, when refrigerant is added to equipment during a service or maintenance event. The method starts at S400 and proceeds to S405 when the system receives the Asset ID, the date of service and the amount of gas added to the equipment. The system uses the Asset ID to identify the capacity and the zip code of the piece of equipment S406, and then determines if the total refrigerant capacity for the piece of equipment does not exceed a first threshold S407, for example, a minimum threshold to which regulatory limitations applicable to the zip code in which the equipment is located may apply. In another embodiment, the first threshold can be set by an authorized user. If the refrigerant capacity of the equipment does not exceed the first threshold, the method is ended S440.

If the total refrigerant capacity of the equipment exceeds the first threshold S407, the system determines in S410 whether an amount of gas added to the equipment exceeds a second threshold S410. The second threshold may be based on the lowest amount set by any regulation applicable to such equipment anywhere in the country, the local regulatory limits applicable by virtue of the zip code in which the equipment is located, or a specific threshold amount chosen by a customer or other authorized user. If the amount of gas added to the equipment exceeds the second threshold S410, the method proceeds to S425. Alternatively, if the amount of gas added to the equipment does not exceed the second threshold S410, the system determines whether the percentage of the equipment's total refrigerant capacity added to the equipment exceeds a third threshold S420.

The third threshold can be another regulatory threshold based on the zip code in which the equipment is location or a value set by an authorized user. If the third threshold is not exceeded, the method ends S440. If the third threshold is exceeded, the system proceeds to S425. At S425, the system sets a date for a follow-up test to determine if the leak has been fixed. If the system determines the follow-up date is within a predetermined period (e.g., one week) S430, the system generates a notification directing a technician to retest the equipment for leaks S435 and the method ends S440. This notification may include the date for the follow-up test as well as an indication of the equipment to be tested. In one embodiment, the notification includes the zip code for efficient routing of the service call. If the system determines the follow-up date is not within the predetermined period, the system waits until the date is within the predetermined period.

Accordingly, in one embodiment of a method for identifying and managing equipment leaks, the method comprises (1) receiving the Asset ID, date of service, and amount of gas added to the equipment; (2) determining the capacity and zip code of the equipment using the Asset ID received; (3) determining whether the amount of refrigerant that the equipment is capable of holding exceeds a first threshold; (4) determining whether the amount of refrigerant added to the equipment exceeds a second threshold; (5) determining whether the amount of gas added to the equipment during the last service or maintenance event as a percent of the equipment's total refrigerant capacity exceeds a third threshold; (6) setting a date for follow-up testing; and (7) generating a notification of the date for follow-up testing.

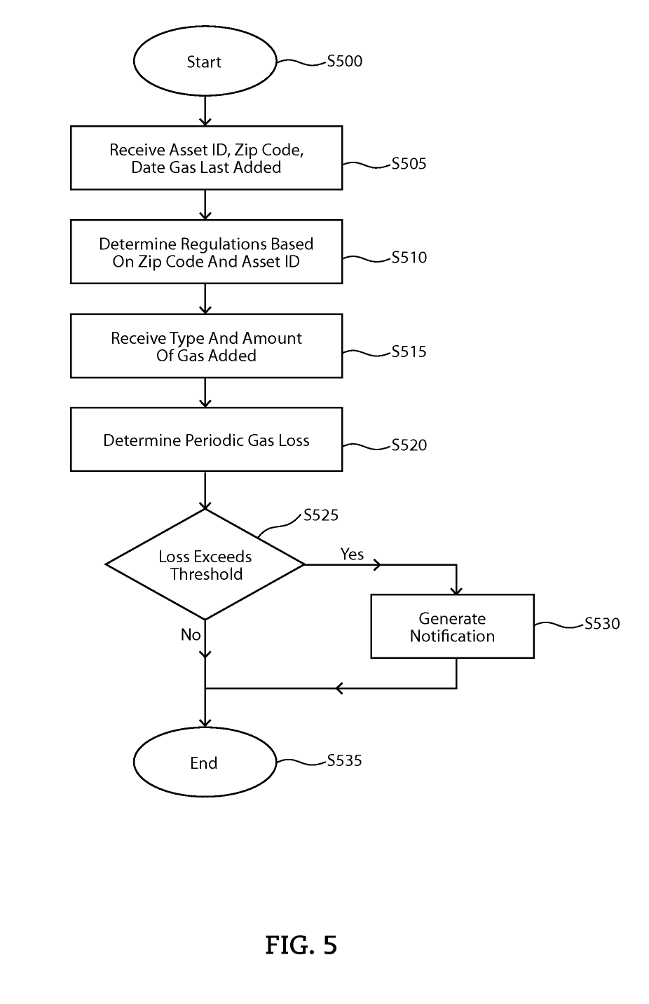

FIG. 5 illustrates an embodiment of a method for periodically monitoring equipment for leaks over time. The method of this embodiment may be initiated when refrigerant is added to a piece of equipment. The method begins at S500 and proceeds to S505 when the system receives the Asset ID, zip code, and the date refrigerant was last added to the equipment. The system determines the applicable regulatory leak rate limits based on the equipment zip code associated with the Asset ID S510 and then receives the type and amount of refrigerant added to the equipment S515. The system determines a periodic leak rate by extrapolating the amount of refrigerant lost since the date refrigerant was last added to the equipment over a period of time set by, e.g., the applicable regulations S520. The period of time can also be set by an authorized user. If the periodic rate of loss exceeds the threshold S525, the system generates a notification S530 and the method ends S535. In one embodiment, the notification may advise the user about the leak so that appropriate remedial action can be taken. If the periodic rate of loss does not exceed the threshold S525, the method ends S535. In such case, no remedial action is needed and the database record associated with the corresponding Asset ID is updated to reflect the actions taken and information received.

Accordingly, in one embodiment of a method for monitoring equipment for leaks over time, the method comprises (1) receiving the Asset ID, zip code of the equipment, and the date refrigerant was last added to the equipment; (2) determining a threshold, e.g., the applicable regulatory leak limits based on the zip code associated with the Asset ID; (3) receiving the type and amount of gas last added to the system; (4) determining the periodic rate of loss of gas from the equipment; and (5) generating a notification if the periodic rate of loss exceeds the threshold.

Refrigeration Equipment Maintenance

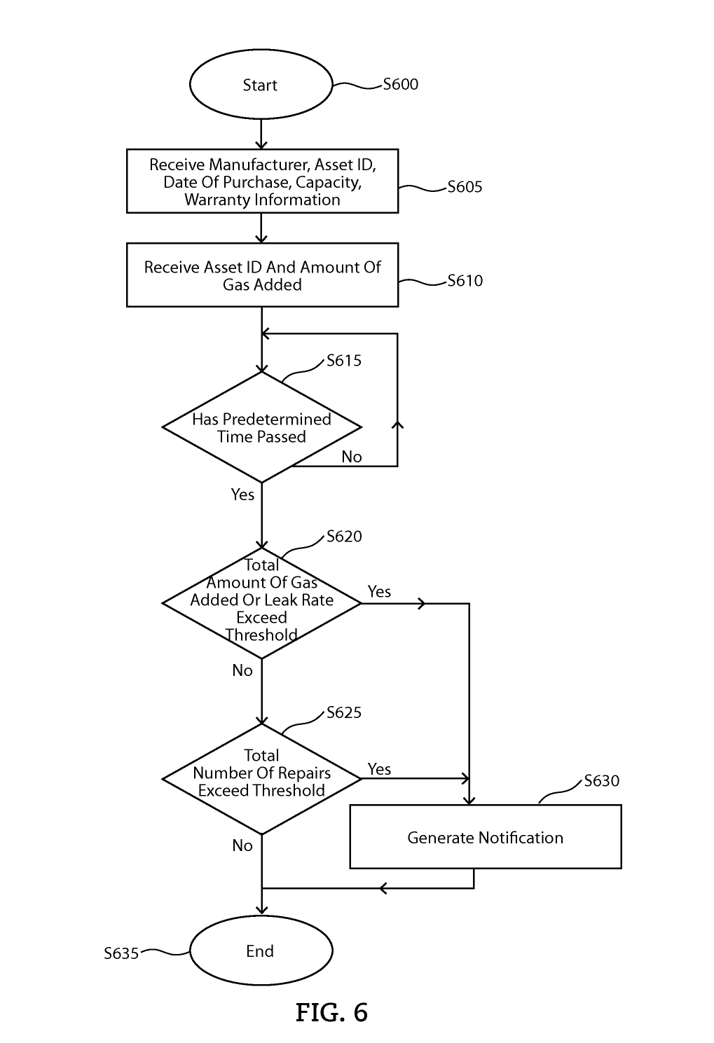

In another aspect, the refrigerant management system provides a method for maintaining a record of the maintenance history for a piece of refrigeration equipment or refrigeration asset. FIG. 6 illustrates one embodiment of a method for tracking the maintenance history of equipment, wherein the predetermined values and thresholds can be based on regulations applicable to the equipment or those set by an authorized user. In such embodiment, the method may be initiated when service or maintenance for a given piece of equipment is requested or required. Alternatively, the method may be initiated on a periodic basis, for example, annually. The method begins at S600 and proceeds to S605 when the system receives the Asset ID, refrigerant capacity, warranty information, manufacturer and date of purchase of the equipment. This reception can occur at a time of purchase or installation of the equipment. A service technician may perform a requested or required maintenance. The technician performing the service scans the tag associated with the equipment and sends the Asset ID and the amount of gas added during the service provided. The system receives the Asset ID and the amount of gas added to the equipment by the technician during the service or maintenance event S610. If a predetermined time has passed since the last execution of the method S615, the system determines whether the total amount of gas added to the equipment or the periodic leak rate (such as determined by the algorithm of FIG. 5) exceeds a threshold S620. If the total amount of gas added and the periodic leak rate do not exceed their respective thresholds, the system determines whether the number of repairs over a given period of time exceeds another threshold S625. If the total amount of gas, the periodic leak rate, or the number of repairs exceeds their respective thresholds, the system determines and generates a notification detailing the manufacturer, the equipment capacity, and the warranty information S630, based on the Asset ID received at S610. After the notification is generated, the system advances to S635. If the respective thresholds are not exceeded, the method proceeds to S635. Then, the method ends S635. Any repairs may be performed and the database record associated with the corresponding Asset ID updated to reflect the actions taken and data received. This method can provide an assessment of equipment performance and reliability over time.

Accordingly, in one embodiment of a method for tracking the maintenance history of an piece of equipment, the method comprises (1) registering the Asset ID, refrigerant capacity, warranty information, manufacturer and date of purchase; (2) receiving the Asset ID and amount of gas added; (3) determining whether the amount of gas added, periodic rate of loss of gas from the equipment, or total number of repairs exceeds a threshold; and if so (5) determining and generating a notification, based on the Asset ID.

Refrigerant Logistics and Distribution

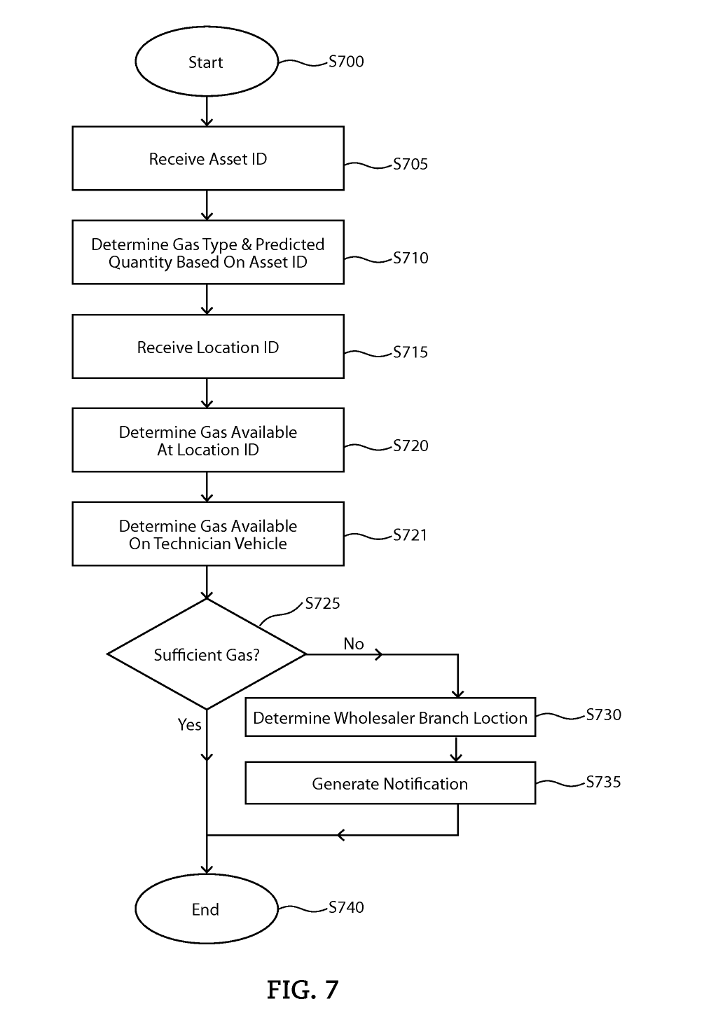

In yet another aspect of the refrigerant management system, a method for managing refrigerant distribution logistics is provided. FIG. 7 illustrates one embodiment of a method for managing the logistics of refrigerant distribution to customer equipment. The method may be initiated when a customer requests delivery of refrigerant to piece of equipment. A technician then receives a work order requesting the provision of refrigerant to a specific piece of equipment, and the technician identifies the corresponding Asset ID. The method begins at S700 and proceeds to S705 when the system receives the Asset ID. The system then determines the type and predicted quantity of refrigerant required based on the Asset ID S710. A predicted quantity can be determined by determining whether a full tank (e.g., 30 pounds) of gas is required. This quantity can be determined from parameters defined by the system (e.g., the type of work requested) or can be based on historic data of a particular Asset ID or type of equipment. The system then receives the Location ID S715 to determine the amount of refrigerant available at the equipment location S720 or on the technician's vehicle S721. If there is sufficient refrigerant available at the equipment location or on the technician's vehicle S725, the method ends S740. If there is insufficient refrigerant at the equipment location or on the technician's vehicle S725, the system determines the nearest wholesaler branch location S730. The nearest wholesaler branch can be determined based on e.g., a technician's home address, an address of of the equipment location, or a route to the equipment location. The branch can also be determined based on a current GPS location. The system then notifies the technician of the location of the branch and the type and predicted amount of refrigerant needed S735 before the method ends S740.

Accordingly, in one embodiment of a method for managing the logistics of distribution of refrigerant to customer refrigerant equipment, the method comprises (1) receiving the Asset ID; (2) determining the type and predicted amount of refrigerant based on the Asset ID received; (3) receiving the location ID; (4) determining the amount of refrigerant available at the location ID; (5) determining the refrigerant wholesaler branch location based on the location ID; and (6) notifying a technician of the branch location, refrigerant type and predicted amount needed if the amount of refrigerant available at the equipment location is insufficient.

Technician Fraud

In still yet another aspect, the system provides a method for validating the amount and type of gas reportedly added to a tank over the life of the tank. By monitoring the amount of refrigerant added to and removed from the tank over time, the method ensures that a customer is only charged for the exact amount of refrigerant actually recycled or repurchased, rather than an estimated or fraudulent amount.

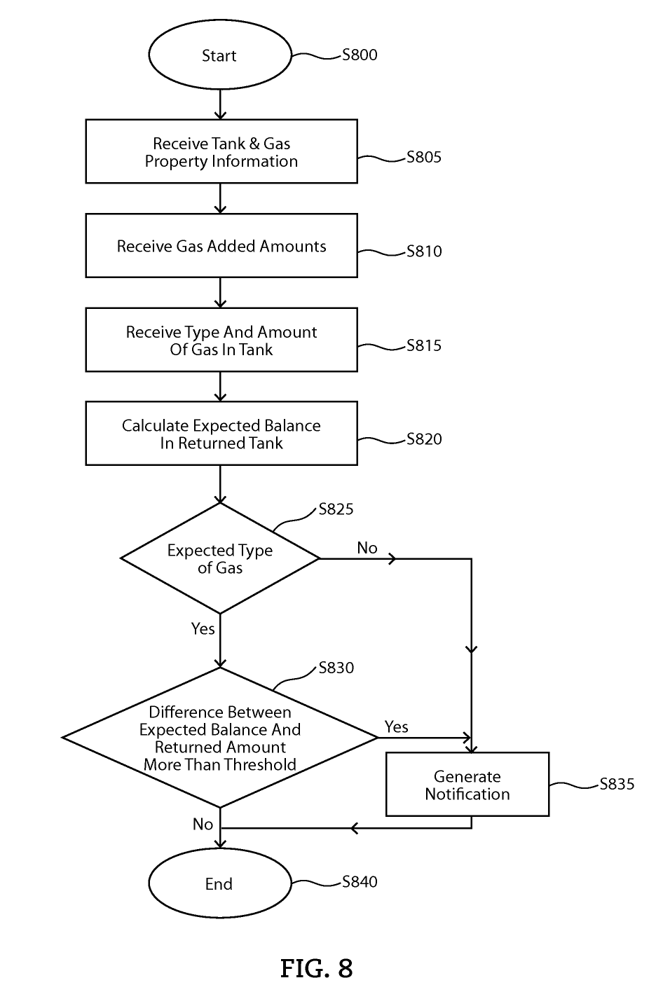

FIG. 8 illustrates one embodiment of a method for validating the amount and type of gas reportedly added to a piece of equipment from a refrigerant tank. The method may be initiated when a tank is returned at the end of its life. The method begins at S800 and proceeds to S805 when the system receives the tank and gas properties information S805. The system then receives the amounts of refrigerant added over the course of the lifetime of the tank to or from other tanks or equipment monitored by the system S810. A technician tests the refrigerant in the tank to determine the type and amount of refrigerant remaining in the tank. The system then receives the type and amount of refrigerant in the returned tank S815 and calculates the expected balance of refrigerant remaining in the tank based on the capacity of the tank and the amounts removed and added over its lifetime S820. If the type of refrigerant actually contained in the tank is not the type of refrigerant expected to be in the tank S825 or if a difference between the expected balance of refrigerant in the tank and the amount actually returned is greater than a threshold selected by an authorized user S830, the system generates a notification S835 and the method ends S840. The notification may comprise, for example, a notice advising the customer of the discrepancy in expected type or balance of gas returned. Alternatively, if the type of gas returned is the type of gas expected S825 and if difference between the expected balance of gas in the tank and the amount actually returned is less than the threshold S830, the method ends S840. In such case, the system credits or debits the customer's gas bank appropriately.

Accordingly, in one embodiment of a method for validating the amount and type of gas reportedly added to a refrigerant tank, the method comprises (1) receiving the Tank ID and gas properties information for the tank; (2) receiving the amounts of refrigerant added to the tank over a period of time based on the tank ID; (3) calculating the balance of refrigerant expected to be remaining in the tank based on the received amounts; and (4) generating a notification if the type of gas actually contained in the tank is not the type of refrigerant expected to be in the tank or if the difference between the expected balance of refrigerant in the tank and the amount actually returned is greater than a threshold.

FIG. 9 shows an exemplary computing device of the system. The device can include a processor, random access memory (RAM), read-only memory (ROM), a hard drive, a keyboard, speakers, mouse, external memory, a network interface, a display, and a CD/DVD drive. In some embodiments, fewer components are present (e.g., no mouse). In other embodiments, additional components are present (e.g., a microphone).

The processor is any processor that can be configured to execute the algorithms set forth in this description. The processor can be, e.g., programmable array logic (PAL), generic array logic (GAL), an Intel Pentium processor, an AMD Athlon processor, or any other processor. The processor can be a 16-bit processor, a 32-bit processor, a 64-bit processor, or any other suitable processor. The processor can include one or more processing cores. Such a processor is an example of a processing means.

The RAM is a memory commonly used as a work area for an executing program. The ROM is a memory commonly used for storing programs executed at boot-up. The hard drive is a drive commonly used for storing applications and other programs not necessarily required at boot-up. The hard drive can be optical, magnetic, or a solid state drive, as well as any other appropriate technology. The RAM, ROM, and hard drive are examples of a storing means.

The keyboard can be any kind of known keyboard, such as QWERTY, Dvorak, or a numeric keypad. The speakers output sounds generated by the system, such as a notification. The mouse is used as a user-input device and can use a ball or an infrared light. The external memory can be, e.g., a disk drive or a jump drive. The network interface connects the computer to another computer over a network, such as the Internet, a local area network (LAN), or a wide area network (WAN). The network interface can be a modem or an Ethernet card, in some embodiments. The network interface can transmit and/or receive wired or wireless communications. The network interface can also use Bluetooth technologies in some examples. The network interface is an example of a networking means. The display can display records from the database or the notifications generated by the system. In some embodiments, the display is a touch screen and can receive user inputs. The CD/DVD drive is an example of an optical disc drive. The optical disc drive an accept Blu-ray discs in one embodiment. Of course, the CD/DVD drive can be supplemented with or replaced by an opto-magnetic disc drive, in one example.

In some embodiments of the present disclosure, the algorithms are executed by the processor. These algorithms can be stored on a non-transitory medium, such as in the cache in the processor, ROM, RAM, hard drive, external memory, or on a disc read by the CD/DVD drive. The algorithms can also be stored in a transitory medium, such as a propagating wave or a signal received by the network interface. A transitory medium can also include software by itself.

### Other Embodiments

Although many of the embodiments described herein describe features that can manage, track and bank different types of refrigerants, other embodiments are designed to manage and bank non-refrigerant gases or specific types of refrigerants only. In one embodiment, the system is used to monitor and manage Helium and Helium-dependent equipment, such as Magnetic Resonance Imaging (MRI) machines. In another embodiment, the system is used to monitor and manage rare gases, the tanks used to transport and store them and the equipment that use them, such as Xenon, Krypton and Neon.

In one embodiment, the system can calculate not only the quantity of the gas being monitored, but also the potential liability represented by the gas being monitored. For example, the embodiment shown in FIGS. 5 and 6 can further comprise determining the potential remediation costs or the carbon credits required to offset the periodic gas loss S520 from a particular piece of equipment.

Interpretation

These and other advantages of the refrigerant management system described herein will be further understood and appreciated by those skilled in the art by reference to the following written specifications, claims and appended drawings.

Preferred embodiments of the invention are described herein. Variations of those preferred embodiments can become apparent to those having ordinary skill in the art upon reading the foregoing description. The inventors expect that skilled artisans will employ such variations as appropriate, and the inventors intend for the invention to be practiced other than as specifically described herein. Accordingly, this invention includes all modifications and equivalents of the subject matter recited in the claims appended hereto as permitted by applicable law. Moreover, any combination of the above-described elements in all possible variations hereof is encompassed by the invention unless otherwise indicated herein or otherwise clearly contradicted by context.

While the disclosure above sets forth the principles of the present invention, with the examples given for illustration only, one should realize that the use of the present invention includes all usual variations, adaptations and/or modifications within the scope of the claims attached as well as equivalents thereof.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing an invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., “including, but not limited to,”) unless otherwise noted. Recitation of ranges as values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention (i.e., “such as, but not limited to,”) unless otherwise claimed. No language in the specification should be construed as indicating any non-claimed element as essential to the practice of the invention.

Those skilled in the art will appreciate from the foregoing that various adaptations and modifications of the just described embodiments can be configured without departing from the scope and sprit of the invention. Therefore, it is to be understood that, within the scope of the appended claims, the invention can be practiced other than as specifically described herein.

What is claimed is:

1. A method of managing a refrigerant, comprising:
receiving a customer ID;
receiving a first amount of the refrigerant in a tank;
crediting the first amount of the refrigerant to an account based on the customer ID;
determining a difference between the first amount of the refrigerant and a second amount of the refrigerant; and
removing the second amount of the refrigerant from the account.

2. The method of claim 1, further comprising:
receiving a purity of the refrigerant in the tank.

3. The method of claim 1, further comprising:
receiving a gas type of the refrigerant in the tank.

4. The method of claim 1, further comprising:
paying the account for the second amount of the refrigerant.

5. A method, comprising:
identifying a plurality of tanks containing a refrigerant using assigned tags; associating each tank with an electronic record for that tank; and retrieving a gas type, weight and purity of the refrigerant based on the assigned tag.
